(19) United States
(12) Patent Application Publication
(10) Pub. No.: US 2014/0339288 A1
(43) Pub. Date: Nov. 20, 2014

(54) PRODUCTION METHOD OF MULTILAYER CLAD MATERIAL

(71) Applicant: SHOWA DENKO K.K., Tokyo (JP)

(72) Inventor: Atsushi OTAKI, Oyama-shi (JP)

(73) Assignee: SHOWA DENKO K.K., Tokyo (JP)

(21) Appl. No.: 14/254,146

(22) Filed: Apr. 16, 2014

(30) Foreign Application Priority Data
May 17, 2013 (JP) 2013-104698

(51) Int. Cl. B23K 20/04; B23K 20/00

(52) U.S. Cl. CPC B23K 20/04; B23K 20/008
USPC 228/117

(57) ABSTRACT

A production method includes a rolling step of obtaining a laminated plate by clad rolling first and second metallic plates in a superposed manner at a rolling reduction of 25% to 85%, a surface activation treatment step of subjecting at least joint scheduled surfaces of the laminated plate 20 and a third metallic plate 3 to a surface activation treatment in vacuum, and a cold pressure welding step of, after performing the surface activation treatment, in vacuum, cold pressure welding the laminated plate 20 and the third metallic plate 3 in a superposed manner that the joint scheduled surfaces thereof are in contact with each other by and between a pair of pressure rolls 44 and 44 so that a rolling reduction becomes 0.1% to 15%.

### TECHNICAL FIELD

The present invention relates to a method of producing a multilayer clad material which is preferably used as, for example, a multilayered material for insulating substrates used for heat dissipation, etc., of a semiconductor element.

In this specification, the term “multilayer” denotes a “multiple layer having three or more layers.”

Further, in this specification, the term “nickel plate” is used so as to include a Ni plate and a Ni alloy plate, the term “titanium plate” is used so as to include a Ti plate and a Ti alloy plate, and the term “aluminum plate” is used so as to include an Al plate and an Al alloy plate. Further, in this specification, the term “metallic plate” is used so as to include metallic plates made of single metal and an alloy plate.

Further, in this specification, the term. “plate” such as a nickel plate is used so as to include a plate, a sheet, a foil, etc., and those having a thickness of 4 μm to 10 mm are collectively called “plate.”

Further, in this specification, the term “dissimilar metallic materials” are used so as to include not only metallic materials different in constituent metallic element (for example, one is a Ni plate and the other is a Ti plate) but also metallic materials same in constituent metallic element but different in composition ratio (for example, one is an Al—Si alloy material in which the Si content rate is 10 mass % and the Al content rate is 90 mass %, and the other is an Al—Si alloy material in which the Si content rate is 15 mass % and the Al content rate is 85 mass %).

### BACKGROUND ART

A semiconductor module such as a power semiconductor module, etc., is equipped with a head dissipation member (e.g., a heat sink, a cooler) for releasing heat generated from a semiconductor element by the operation of the semiconductor element. Further, in this semiconductor module, a heat dissipation insulating substrate for transmitting the heat generated by the semiconductor to the heat dissipation member is arranged between the semiconductor element and the heat dissipation member. This insulating substrate functions as a conductor thermally and as an insulating material electrically, and is concretely provided with a ceramic layer as an electric insulation layer and a metallic layer including a wiring layer (circuit layer) joined to one surface of the ceramic layer (see, e.g., Patent Documents 1 to 4). A semiconductor element is joined to a metallic layer of an insulating substrate by soldering.

As a layer constituting a metallic layer, in recent years, an aluminum layer made of Al or Al alloy is used. The reasons are that an aluminum layer is excellent in electric characteristics and thermal characteristics, and that using an aluminum layer enables weight saving as compared with a conventional insulating substrate using Cu and also enables production cost reduction of the insulating substrate.
Patent Document 1: Japanese Unexamined Laid-open Patent Application Publication No. 2004-328012
Patent Document 2: Japanese Unexamined Laid-open Patent Application Publication No. 2004-235503
Patent Document 3: Japanese Unexamined Laid-open Patent Application Publication No. 2006-303346
Patent Document 4: Japanese Unexamined Laid-open Patent Application Publication No. 2009-147123

### Problems to be Solved by the Invention

However, an aluminum layer is poor in solder joining property. Therefore, it is performed to form a Ni plated layer on a surface of an aluminum layer so that a semiconductor element can be joined thereto by soldering. In this case, however, an alloy layer poor in strength is formed at a joint interface between the aluminum layer and the Ni plated layer. As a result, by the thermal stress (thermal strain) generated by the cold heat cycle, there arise problems that cracks and/or separations readily occur in the alloy layer and deformation (unevenness) readily occurs on the surface of the Ni plated layer.

Under the circumstances, the present inventors have conceived a strategy of using a material as a wiring layer material in which a nickel layer made of Ni or Ni alloy having a surface on which a semiconductor element is joined, a titanium layer made of Ti or Ti alloy, and an aluminum layer made of Al or Al alloy are laminated in this order by a clad rolling method or a discharge plasma sintering method.

However, in the multilayer clad material obtained by a discharge plasma sintering method, joining can be performed regardless of the structural ratio of the thickness of each material at the time of performing multilayer cladding. However, there is a problem that the method is a small amount batch method, which is not suitable for a mass production, and therefore the production cost is expensive.

On the other hand, the multilayer clad material obtained by a clad rolling method is excellent in mass productivity. However, there is a problem that, in producing a multilayer (three or more layer) clad material, a layer to be arranged in the middle thereof has a limitation in the structural thickness ratio acceptable by the difference of the physical properties (strength, elongation, etc.) between the layer to be arranged in the middle and the material to be arranged on the outer side thereof. For example, there is a problem that if it is designed without paying attention to this limitation, the layer (titanium layer in the aforementioned multilayer clad material) arranged in the middle breaks or even if no breakage occurs, the thickness cannot be controlled to have a desired thickness with a high degree of accuracy. In cases where the thickness cannot be controlled to have a desired thickness with a high degree of accuracy, for example, desired thermal characteristics cannot be obtained.

Further, in a clad rolling method, it is required to perform a diffusion heat treatment to increase a joint strength of the joint interface. However, performing a heat treatment to a clad material in which two or more layers in which dissimilar metallic materials are joined causes curves and/or undulations in the material (especially, in a wide material, curves and/or undulations occur notably) due to the difference of raw material, which makes it difficult to roll up the clad material into a coil form. Especially, when a multilayer clad material having three or more layers is produced by a clad rolling method, curves and/or undulations occur notably in the material, which prevents the multilayer clad material from being rolled up into a coil form. For this reason, it is practically difficult to produce it.

The present invention was made in view of the aforementioned technical background, and aims to provide a production method of a multilayer clad material capable of mass-producing a multilayer clad material of three or more layers at low cost, wherein the multilayer clad material has no curve, a thickness of each constituent layer is controlled with a high degree of accuracy and no crack and/or separation occurs in the constituent layer even if a cold heat is applied.

### Means for Solving the Problems

In order to attain the aforementioned objects, some preferred embodiments of the present invention provide the following measures.

(1) A production method of a multilayer clad material, comprising:

a rolling step of obtaining a laminated plate by clad rolling a first metallic plate and a second metallic plate made of dissimilar metallic materials or same metallic material in a superposed manner at a rolling reduction of 25% to 85%;

a surface activation treatment step of subjecting at least a joint scheduled surface of the laminated plate and at least a joint scheduled surface of a third metallic plate to a surface activation treatment in vacuum; and

a cold pressure welding step of, after performing the surface activation treatment, in vacuum, cold pressure welding the laminated plate and the third metallic plate by and between a pair of pressure rolls so that a rolling reduction becomes 0.1% to 15% in a superposed manner that the joint scheduled surface of the laminated plate and the joint scheduled surface of the third metallic plate are in contact with each other.

(2) The production method of a multilayer clad material as recited in the aforementioned Item (1), wherein

a thickness of the first metallic plate is 0.5 to 2.0 times a thickness of the second metallic plate, and

a thickness of the third metallic plate is over 2.0 times or less than 0.5 times a thickness of the second metallic plate.

(3) The production method of a multilayer clad material as recited in the aforementioned Item (1), wherein a thickness of at least one of metallic plates between the first metallic plate and the second metallic plate is 100 μm or less.

(4) A production method of a multilayer clad material, comprising:

a rolling step of obtaining a laminated plate by clad rolling a nickel plate and a titanium plate in a superposed manner at a rolling reduction of 25% to 85%;

a surface activation treatment step of subjecting at least a surface of the titanium plate of the laminated plate and at least a joint scheduled surface of an aluminum plate to a surface activation treatment in vacuum; and

a cold pressure welding step of, after performing the surface activation treatment, in vacuum, cold pressure welding the laminated plate and the aluminum plate by and between a pair of pressure rolls so that a rolling reduction becomes 0.1% to 15% in a superposed manner that the surface of the titanium plate of the laminated plate and a joint scheduled surface of the aluminum plate are in contact with each other.

(5) The production method of a multilayer clad material as recited in the aforementioned Item (4), wherein

a thickness of the nickel plate is 0.5 to 2.0 times a thickness of the titanium, and

a thickness of the aluminum plate is over 2.0 times or less than 0.5 times a thickness of the titanium plate.

(6) The production method of a multilayer clad material as recited in the aforementioned Item (4), wherein

a thickness of the nickel plate is 10 μm to 100 μm,

a thickness of the titanium plate is 5 μm to 30 μm, and

a thickness of the aluminum plate is within a range of over 60 μm to 10 mm or less.

(7) A production method of a multilayer clad material, comprising:

a first rolling step of obtaining a first laminated plate by clad rolling a first metallic plate and a second metallic plate made of dissimilar metallic materials or same metallic material in a superposed manner at a rolling reduction of 25% to 85%;

a second rolling step of obtaining a second laminated plate by clad rolling a third metallic plate and a fourth metallic plate made of dissimilar metallic materials or same metallic material in a superposed manner at a rolling reduction of 25% to 85%;

a surface activation treatment step of subjecting at least a joint scheduled surface of the first laminated plate and at least a joint scheduled surface of the second laminated plate to a surface activation treatment in vacuum; and

a cold pressure welding step of, after performing the surface activation treatment, in vacuum, cold pressure welding the first laminated plate and the second laminated plate by and between a pair of pressure rolls so that a rolling reduction becomes 0.1% to 15% in a superposed manner that the joint scheduled surface of the first laminated plate and the joint scheduled surface of the second laminated plate are in contact with each other.

(8) The production method of a multilayer clad material as recited in the aforementioned Item (7), wherein

a thickness of the first metallic plate is 0.5 to 2.0 times a thickness of the second metallic plate,

a thickness of the fourth metallic plate is 0.5 to 2.0 times a thickness of the third metallic plate, and

a thickness of the third metallic plate is over 2.0 times or less than 0.5 times a thickness of the second metallic plate.

(9) The production method of a multilayer clad material as recited in the aforementioned Item (7), wherein a thickness of at least one metallic plate among the first to fourth metallic plates is 100 μm or less.

(10) A production method of a multilayer clad material, comprising:

a first rolling step of obtaining a first laminated plate by clad rolling a nickel plate and a titanium plate in a superposed manner at a rolling reduction of 25% to 85%;

a second rolling step of obtaining a second laminated plate by clad rolling an aluminum plate and a brazing plate in a superposed manner at a rolling reduction of 25% to 85%;

a surface activation treatment step of subjecting at least a surface of the titanium plate of the first laminated plate and at least a surface of the aluminum plate of the second laminated plate to a surface activation treatment in vacuum; and

a cold pressure welding step of, after performing the surface activation treatment, in vacuum, cold pressure welding the first laminated plate and the second laminated plate by and between a pair of pressure rolls at a rolling reduction of 0.1% to 15% in a superposed manner that a surface of the titanium plate of the first laminated plate and a surface of the aluminum plate of the second laminated plate are in contact with each other.

(11) The production method of the multilayer clad material as recited in the aforementioned Item (10), wherein

a thickness of the nickel plate is 0.5 to 2.0 times a thickness of the titanium plate,

a thickness of the brazing plate is 0.5 to 2.0 times a thickness of the aluminum plate, and

a thickness of the aluminum plate is over 2.0 times or less than 0.5 times a thickness of the titanium plate.

(12) The production method of the multilayer clad material as recited in the aforementioned Item (10), wherein

a thickness of the nickel plate is 10 μm to 100 μm,

a thickness of the titanium plate is 5 μm to 30 μm,

a thickness of the aluminum plate is within a range of over 60 μm to 10 mm or less, and

a thickness of the brazing plate is 10 μm to 60 μm.

(13) The production method of the multilayer clad material as recited in any one of the aforementioned Items (1) to (12), wherein the surface activation treatment is plasma etching processing.

(14) The production method of the multilayer clad material as recited in any one of the aforementioned Items (1) to (13), wherein a temperature of the pressure rolls at a time of the cold pressure welding in the cold pressure welding step is within a range of 10° C. to 80° C.

(15) The production method of the multilayer clad material as recited in any one of the aforementioned Items (1) to (14), wherein the rolling reduction of the clad rolling in the rolling step is 45% to 65%.

(16) The production method of the multilayer clad material as recited in any one of the aforementioned Items (1) to (15), wherein the multilayer clad material is a multilayered material for insulating substrates.

In the production method according to the embodiment as recited in Item (1), since the first metallic plate and the second metallic plate are clad rolled at a rolling reduction of 25% to 85% in a superposed manner in the rolling step, a laminated plate in which the first metallic plate and the second metallic plate are laminated can be obtained at low cost.

Thereafter, in vacuum, at least a joint scheduled surface of the laminated plate (hereinafter, the metallic plate of the laminated plate to be joined will be referred to as “second metallic plate”) and at least a joint scheduled surface of a third metallic plate are subjected to a surface activation treatment. This removes oxides, absorbed substances, etc., on the joint scheduled surfaces to expose the cleaned surfaces, which in turn can improve the joint strength.

In the cold pressure welding step, in vacuum, the laminated plate and the third metallic plate are superposed and cold pressure welded by and between a pair of pressure rolls so that the rolling reduction becomes as low as 0.1% to 15%. Therefore, even in cases where a thickness of the third metallic plate and a thickness of the second metallic plate differ significantly (for example, the thickness of the third metallic plate is two or more times or less than 0.5 times the thickness of the second metallic plate), it is possible to obtain a multilayer clad material in which the thickness of the thinner metallic plate is controlled with a high degree of accuracy. Further, since the cold pressure welding is performed so that the rolling reduction becomes as low as 0.1% to 15%, there are advantages that the joint interface of the third metallic plate and the second metallic plate becomes excellent in flatness and no alloy layer (the alloy layer causes negative effects on mechanical characteristics such as joint strength, etc., and/or electric characteristics) will be formed at the joint interface of the third metallic plate and the second metallic plate. Further, the cold pressure welding is performed so that the rolling reduction becomes as low as 0.1% to 15% and no diffusion heat treatment is required thereafter (a diffusion heat treatment can be omitted). Therefore, even in the case of using a wide width material, a multilayer clad material with no curve can be obtained.

In the production method according to the embodiment as recited in Item (2), although the thickness of the third metallic plate is over 2.0 times or less than 0.5 times the thickness of the second metallic plate and the thicknesses of both the plates differ significantly, it is possible to obtain a multilayer clad material in which the thickness of the thinner metallic plate is controlled with a high degree of accuracy.

In the production method according to the embodiment as recited in Item (3), although at least one of metallic plates between the first metallic plate and the second metallic plate is a thin plate having a thickness of 100 μm or less, it is possible to obtain a multilayer clad material in which the thickness of the thinner metallic plate is controlled with a high degree of accuracy.

In the production method according to the embodiment as recited in Item (4), since the nickel plate and the titanium plate are superposed and clad rolled at a rolling reduction of 25% to 85% in the rolling step, a laminated plate in which the nickel plate and the titanium plate are laminated can be obtained at low cost.

Thereafter, in vacuum, at least the surface of the titanium plate of the laminated plate and at least the joint scheduled surface of the aluminum plate are subjected to a surface activation treatment. Therefore, oxides, absorbed substances, etc., on these joint scheduled surfaces can be removed to expose the cleaned surfaces, which in turn can improve the joint strength.

In the cold pressure welding step, in vacuum, the laminated plate and the aluminum plate are superposed, and these plates are cold pressure welded by and between a pair of pressure rolls so that the rolling reduction becomes as low as 0.1% to 15%. Therefore, even in cases where, for example, the thickness of the aluminum plate and the thickness of the titanium plate differ significantly (e.g., the thickness of the aluminum plate is over 2.0 times or less than 0.5 times the thickness of the titanium plate), it is possible to obtain a multilayer clad material in which the thickness of the thinner metallic plate is controlled with a high degree of accuracy. Further, the cold pressure welding is performed so that the rolling reduction becomes as low as 0.1% to 15%. Therefore, there are advantages that the joint interface of the aluminum plate and the titanium plate becomes excellent in flatness and no alloy layer (the alloy layer causes negative effects on mechanical characteristics such as joint strength, etc., and/or electric characteristics) is formed at the joint interface of the aluminum plate and the titanium plate. Further, the cold pressure welding is performed so that the rolling reduction becomes as low as 0.1% to 15% and no diffusion heat treatment is required thereafter (a diffusion heat treatment can be omitted). Therefore, even in the case of using a wide width material, a multilayer clad material with no curve can be obtained.

In the production method according to the embodiment as recited in Item (5), although the thickness of the aluminum plate is over 2.0 times or less than 0.5 times the thickness of the titanium plate and the thicknesses of both the plates differ greatly, it is possible to obtain a multilayer clad material in which the thickness of the thinner metallic plate is controlled with a high degree of accuracy.

In the production method according to the embodiment as recited in Item (6), the thickness of the nickel plate is 10 μm to 100 μm, the thickness of the titanium plate is 5 μm to 30 μm, and the thickness of the aluminum plate is within a range of over 60 μm to 10 mm or less. Although at least the thickness of the titanium plate is thin as mentioned above, it is possible to obtain a multilayer clad material in which the thicknesses of these titanium plate, nickel plate and aluminum plate are controlled with a high degree of accuracy.

In the production method according to the embodiment as recited in Item (7), in the first rolling step, the first metallic plate and the second metallic plate are superposed and clad rolled at a rolling reduction of 25% to 85%. Therefore, it is possible to obtain a first laminated plate in which the first metallic plate and the second metallic plate are laminated at low cost.

In the second rolling step, the third metallic plate and the fourth metallic plate are superposed and clad rolled at a rolling reduction of 25% to 85%. Therefore, it is possible to obtain a second laminated plate in which the third metallic plate and the fourth metallic plate are laminated at low cost.

Thereafter, in vacuum, at least the joint scheduled surface of the first laminated plate (hereinafter, the metallic plate of the first laminated plate to be joined will be referred to as “second metallic plate”) and at least the joint scheduled surface of the second laminated plate (hereinafter, the metallic plate of the second laminated plate to be joined will be referred to as “third metallic plate”) are subjected to a surface activation treatment. Therefore, it is possible to remove oxides, absorbed substances, etc., on these joint scheduled surfaces to expose the cleaned surfaces, which in turn can improve the joint strength.

In the cold pressure welding, in vacuum, the first laminated plate and the second laminated plate are superposed and cold rolled by and between the pair of pressure rolls so that the rolling reduction becomes as low as 0.1% to 15%. Therefore, even in cases where the thickness of the third metallic plate and the thickness of the second metallic plate differ greatly (for example, the thickness of the third metallic plate is over 2.0 times or less than 0.5 times the thickness of the second metallic plate), it is possible to obtain a multilayer clad material in which the thickness of the thinner metallic plate is controlled with a high degree of accuracy. Further, the cold pressure welding is performed so that the rolling reduction becomes as low as 0.1% to 15%, and therefore there are advantages that the joint interface of the third metallic plate and the second metallic plate becomes excellent in flatness and no alloy layer (the alloy layer causes negative effects on mechanical characteristics such as joint strength, etc., and/or electric characteristics) is formed at the joint interface of the third metallic plate and the second metallic plate. Further, the cold pressure welding is performed so that the rolling reduction becomes as low as 0.1% to 15% and no diffusion heat treatment is required thereafter (a diffusion heat treatment can be omitted). Therefore, even in the case of using a wide width material, a multilayer clad material with no curve can be obtained.

In the production method according to the embodiment as recited in Item (8), even in cases where the thickness of the third metallic plate is over 2.0 times or less than 0.5 times the thickness of the second metallic plate, it is possible to obtain a multilayer clad material in which the thickness of the thinner metallic plate is controlled with a high degree of accuracy.

In the production method according to the aforementioned embodiment as recited in Item (9), although at least one thin plate having a thickness of 100 μm or less among the first to fourth metallic plate is included, it is possible to obtain a multilayer clad material in which the thickness of the thin metallic plate is controlled with a high degree of accuracy.

In the production method according to the embodiment as recited in Item (10), in the first rolling step, the nickel plate and the titanium plate are superposed and clad rolled at a rolling reduction of 25% to 85%. Therefore, it is possible to obtain a first laminated plate in which the nickel plate and the titanium plate are laminated at low cost.

Further, in the second rolling step, the aluminum plate and the brazing plate are superposed and clad rolled at a rolling reduction of 25% to 85%. Therefore, it is possible to obtain a second laminated plate in which the aluminum plate and the brazing plate are laminated at low cost.

Thereafter, in vacuum, at least the surface of the titanium plate of the first laminated plate and at least the surface of the aluminum plate of the second laminated plate are subjected to a surface activation treatment, it is possible to remove oxides, absorbed substances, etc., on these joint scheduled surfaces to expose the cleaned surfaces, which in turn can improve the joint strength.

In the cold pressure welding step, in vacuum, the first laminated plate and the second laminated plate are superposed and both plates are cold pressure welded by and between the pair of pressure rolls so that the rolling reduction becomes as low as 0.1% to 15%. Therefore, for example, even in cases where the thickness of the aluminum plate and the thickness of the titanium plate differ greatly (for example, the thickness of the aluminum plate is over 2.0 times or less than 0.5 times the thickness of the titanium plate), it is possible to obtain a multilayer clad material in which the thickness of the thinner metallic plate is controlled with a high degree of accuracy. Further, the cold pressure welding is performed so that the rolling reduction becomes as low as 0.1% to 15%. Therefore, there are advantages that the joint interface of the aluminum plate and the titanium plate becomes excellent in flatness and no alloy layer (the alloy layer causes negative effects on mechanical characteristics such as joint strength, etc., and/or electric characteristics) is formed at the joint interface of the aluminum plate and the titanium plate. Further, the cold pressure welding is performed so that the rolling reduction becomes as low as 0.1% to 15% and no diffusion heat treatment is required thereafter (the treatment can be omitted), and therefore even in the case of using a wide width material, a multilayer clad material with no curve can be obtained.

In the production method according to the embodiment as recited in Item (11), although the thickness of the aluminum plate is over 2.0 times or less than 0.5 times the thickness of the titanium plate and the thicknesses of both the plates differ greatly, it is possible to obtain a multilayer clad material in which the thickness of the thinner metallic plate is controlled with a high degree of accuracy.

In the production method according to the embodiment as recited in Item (12), the thickness of the nickel plate is 10 μm to 100 μm, the thickness of the titanium plate is 5 μm to 30 μm, the thickness of the aluminum plate is within the range of over 60 μm to 10 mm or less, the thickness of the brazing plate is 10 μm to 60 μm, and at least the thickness of the titanium plate is thin. However, it is possible to obtain a multilayer clad material in which the thicknesses of these titanium plate, nickel plate, aluminum plate and brazing plate are controlled with a high degree of accuracy.

In the production method according to the embodiment as recited in Item (13), since the surface activation treatment is performed by plasma etching processing, it is possible to remove oxides, absorbed substances, etc., on the joint scheduled surfaces to expose the cleaned surfaces, which in turn can further improve the joint strength.

In the production method according to the embodiment as recited in Item (14), since the temperature of the pressing rolls at the time of the cold pressure welding in the cold pressure welding step is set within the range of 10° C. to 80° C., it is possible to obtain a multilayer clad material in which the thickness of the thinner metallic plate is controlled with a higher degree of accuracy.

In the production method according to the embodiment as recited in Item (15), in the rolling step, since the clad rolling is performed at the rolling reduction of 45% to 65%, it is possible to stably produce a multilayer clad material without imposing excessive loads on the facility (while controlling the facility cost without requiring large facility capacity).

In the production method according to the embodiment as recited in Item (16), it is possible to produce a multilayer clad material for insulating substrates in which the thickness of the thinner metallic plate is also controlled with a high degree of accuracy and having no curve.

### BRIEF DESCRIPTION OF THE DRAWINGS

FIG. 1 is a cross-sectional view showing one embodiment of a multilayer clad material produced by a first production method according to the present invention.

FIG. 2 is a cross-sectional view showing one embodiment of a multilayer clad material produced by a second production method according to the present invention.

FIG. 3 is a schematic side view showing an example of a production apparatus used in a surface activation treatment step and a cold pressure welding step in a state in which a first production method is being performed.

FIG. 4 is a schematic side view showing an example of a production apparatus used in a surface activation treatment step and a cold pressure welding step in a state in which a second production method is being performed.

FIG. 5 is a cross-sectional view showing an example of an insulating substrate constituted using the multilayer clad material of FIG. 2.

FIG. 6 is a schematic cross-sectional view showing an example of a cooler integrated insulating substrate constituted using the multilayer clad material of FIG. 1 in an exploded state before lamination.

FIG. 7 is a schematic cross-sectional view showing an example of a cooler integrated insulating substrate constituted using the multilayer clad material of FIG. 2 in an exploded state before lamination.

FIG. 8 is a schematic cross-sectional view showing another example of a cooler integrated insulating substrate constituted using the multilayer clad material of FIG. 2 in an exploded state before lamination.

FIG. 9 is a schematic side view showing an example of the semiconductor module.

### EMBODIMENTS FOR CARRYING OUT THE INVENTION

In the following paragraphs, some preferred embodiments of the invention will be described by way of example and not limitation. It should be understood based on this disclosure that various other modifications can be made by those in the art based on these illustrated embodiments.

### [First Production Method]

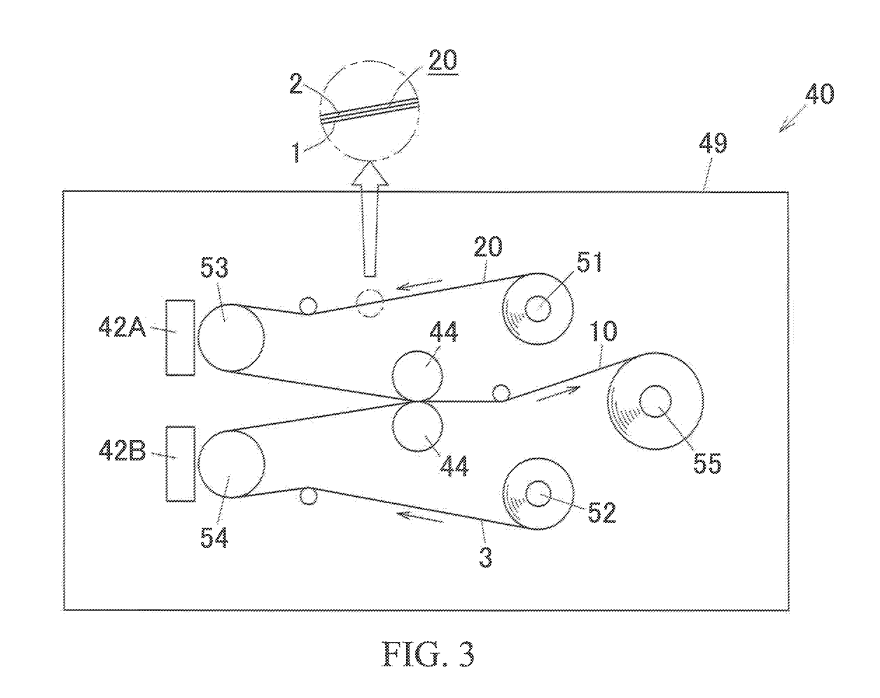

A first production method of a multilayer clad material according to the present invention will be explained with reference to FIG. 3.

### (Rolling Step)

By placing a first metallic plate 1 and a second metallic plate 2 made of dissimilar metallic materials or same metallic material and clad rolling them at a rolling reduction of 25% to 85%, a laminated plate 20 is obtained. For example, a nickel plate is used as the first metallic plate 1 and a titanium plate is used as the second metallic plate 2. That is, for example, by superposing the nickel plate 1 and the titanium plate 2 and clad rolling them at the rolling reduction of 25% to 85%, a laminated plate 20 is obtained. The obtained laminated plate 20 is rolled up on a first supply roll 51.

In this rolling step, the first metallic plate 1 and the second metallic plate 2 are superposed and clad rolled, and therefore the laminated plate 20 in which the first metallic plate 1 and the second metallic plate 2 are laminated can be obtained at low cost.

The clad rolling in the rolling step is preferably performed by cold clad rolling. In this case, since it is not especially required to heat the material (metallic plate), the productivity can be improved. The temperature of the reduction roll at the time of the cold clad rolling is preferably set within a range of 10° C. to 120° C.

The “rolling reduction” is a value obtained by the following calculation formula:

rolling reduction (%)={(M−N)/M}×100,

where “M” (μm) is a total of the thickness of the first metallic plate and the thickness of the second metallic plate before clad rolling, and “N” (μm) is a thickness of the laminated plate 20 obtained by the clad rolling.

Before the rolling step, it is preferable to preliminarily perform mechanical polishing of the joint scheduled surface of the first metallic plate 1 and the joint scheduled surface of the second metallic plate 2. As the mechanical polishing, a method of polishing with a wire brush, for example, is exemplified. But the method is not specifically limited as long as it can mechanically remove a surface oxide layer of the joint scheduled surface. By performing such mechanical polishing (providing a mechanical polishing step), even by the clad rolling at the rolling reduction of, e.g., 25% to 70%, joining with sufficient joint strength can be attained.

Further, after the rolling step but before the subsequent surface activation treatment step, the laminated plate 20 obtained by the clad rolling can be subjected to a diffusion heat treatment at a heat treatment temperature of 500° C. to 700° C. By performing such diffusion heat treatment, the joint strength of the first metallic plate 1 and the second metallic plate 2 can be improved.

### (Surface Activation Treatment Step)

Next, as shown in FIG. 3, the first supply roll 51 on which the laminated plate 20 is wound is arranged in a vacuum chamber 49 of the production apparatus 40, and the other second supply roll 52 on which a third metallic plate 3 is wound is arranged in the vacuum chamber 49. As the third metallic plate 3, for example, an aluminum plate is used.

The vacuum chamber 49 is configured so that the interior space can be made into a vacuum state by a not-illustrated vacuum apparatus. In the vacuum chamber 49, a first electrode roll 53, a surface activation treatment apparatus 42A arranged apart from the first electrode roll 53 at a position close to the first electrode roll 53, a second electrode roll 54, a surface activation treatment apparatus 42B arranged apart from the second electrode roll 54 at a position closed to the second electrode roll 54, a pair of pressure rolls 44 and 44, and a wind-up roll 55 are arranged. The surface activation treatment apparatus 42A is configured to perform plasma etching processing of the surface of the metallic plate fitted on the outer peripheral surface of the first electrode roll 53 by applying a high-frequency voltage having a frequency of 10 MHz to 50 MHz between an electrode in the apparatus 42A and the first electrode roll 53 to irradiate plasma onto the surface of the metallic plate. In the same manner, the surface activation treatment apparatus 42B is configured to perform plasma etching processing of the surface of the metallic plate fitted on the outer peripheral surface of the second electrode roll 54 by applying a high-frequency voltage having a frequency of 10 MHz to 50 MHz between an electrode in the apparatus 42B and the second electrode roll 54 to irradiate plasma onto the surface of the metallic plate.

Next, the inside of the vacuum chamber 49 is maintained in a vacuum state. It is preferable that the degree of vacuum in the vacuum chamber 49 is set to 1×10⁻⁴ Pa to 1 Pa. Further, it is also preferable that the inside of the vacuum chamber 49 is filled with inert gas such as nitrogen, argon, etc., into an inert gas atmosphere and then the degree of vacuum is set to 1×10⁻⁴ Pa to 1 Pa by raising the degree of vacuum.

In the vacuum chamber 49 which is in a vacuum state, the laminated plate 20 unwound from the first supply roll 51 is brought into contact with the outer peripheral surface of the first electrode roll 53 along the outer peripheral surface thereof, plasma is irradiated from the surface activation treatment apparatus 42A onto the surface of the second metallic plate (e.g., titanium plate) 2 of the laminated plate 20 in contact with the first electrode roll 53, and thereafter the laminated plate 20 is fed between a pair of pressure rolls 44 and 44 (see FIG. 3). By the plasma etching processing, it is possible to remove oxides, absorbed substances, etc., on the surface of the second metallic plate (e.g., titanium plate) 2 which is a joint scheduled surface of the laminated plate 20 and expose the cleaned surface.

At the same time, in the vacuum chamber 49 which is in a vacuum state, the third metallic plate (e.g., aluminum plate) 3 unwound from the second supply roll 52 is brought into contact with the outer peripheral surface of the second electrode roll 54 along the outer peripheral surface thereof, plasma is irradiated from the surface activation treatment apparatus 42B onto the surface (joint scheduled surface) of the third metallic plate (e.g., aluminum plate) 3 in contact with the second electrode roll 54, and thereafter the third metallic plate (e.g., aluminum plate) 3 is fed between the pair of pressure rolls 44 and 44 (see FIG. 3). By the plasma etching processing, it is possible to remove oxides, absorbed substances, etc., on the joint scheduled surface of the third metallic plate (e.g., aluminum plate) 3 and expose the cleaned surface.

### (Cold Pressure Welding Step)

Subsequently, in the vacuum chamber 49 which is in a vacuum state, the laminated plate 20 and the third metallic plate 3 (e.g., aluminum plate) are superposed so that the surface of the second metallic plate (e.g., titanium plate) 2 which is a joint scheduled surface of the laminated plate 20 and the joint scheduled surface (one surface) of the third metallic plate (e.g., aluminum plate) 3 are brought into contact with each other and cold pressure welded by and between the pair of pressure rolls 44 and 44 so that the rolling reduction becomes as low as 0.1% to 15% (see FIG. 3).

Thereafter, in the vacuum chamber 49 which is in a vacuum state, the multilayer clad material 10 obtained by the cold pressure welding is wound up on the wind-up roll 55 (see FIG. 3).

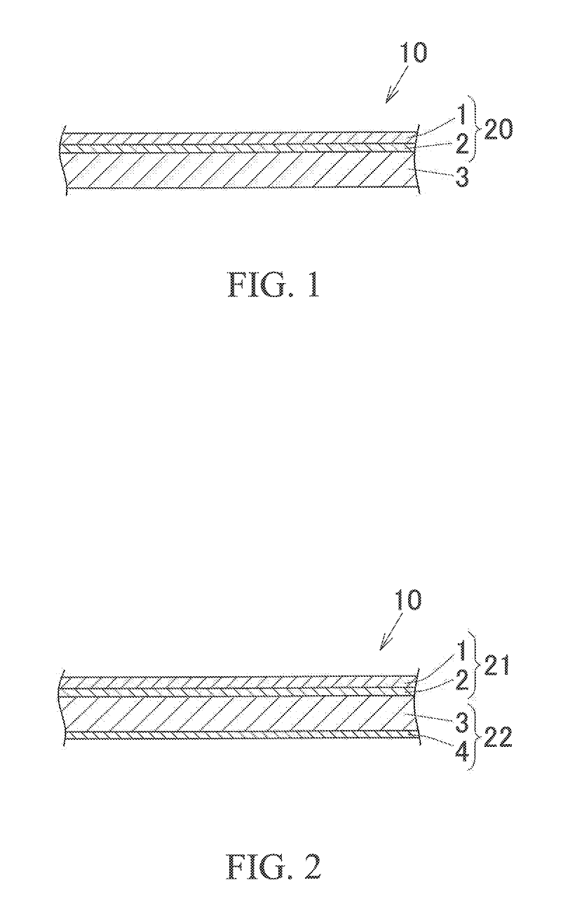

The obtained multilayer clad material 10, as shown in FIG. 1, has a three-layer laminated structure in which the first metallic plate (e.g., nickel plate) 1 is laminated on one surface of the second metallic plate (e.g., titanium plate) 2 and the third metallic plate (e.g., aluminum plate) 3 is laminated on the other surface of the second metallic plate (e.g., titanium plate) 2.

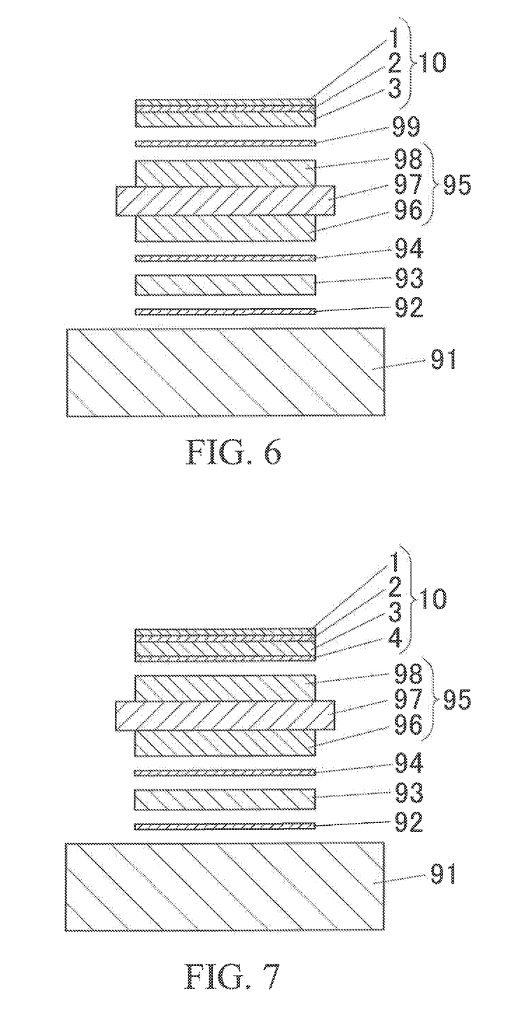

The multilayer clad material 10 having the three-layer laminated structure of the nickel plate 1/titanium plate 2/aluminum plate 3 can be used by being brazed to the semiconductor element joining surface side of a DBA substrate (cooler integrated insulating substrate) 95 with a brazing foil 99 (see FIG. 6) or by being brazed directly to a ceramic plate. FIG. 6 is a schematic cross-sectional view showing an example of a cooler integrated insulating substrate in an exploded state before lamination. In FIG. 6, the reference symbol “91” denotes an aluminum plate as a heat dissipation member, “92” denotes an aluminum brazing foil, “93” denotes an aluminum punching plate, “94” denotes an aluminum brazing foil, “95” denotes a DBA (Al layer 96/AlN layer (aluminum nitride layer) 97/Al layer 98), and “99” denotes an aluminum brazing foil.

In joining using a brazing foil separately as mentioned above, since a brazing material is hard and not suitable for rolling, a special foil rolling apparatus will be required to make a brazing material into a foil having a thickness of 250 μm or less, and that the yield is not good enough. Further, a brazing foil is not good in handling characteristics. Under the circumstances, it is preferable to obtain a multilayer clad material 10 having a four-layer laminated structure of nickel plate 1/titanium plate 2/aluminum plate 3/aluminum brazing plate 4 by applying a second production method which will be detailed later.

In the aforementioned cold pressure welding step, the rolling reduction is set to 0.1% to 15%. By setting the rolling reduction to the range, it is possible to further improve the flatness of the joint interface of the third metallic plate and the second metallic plate, and also possible to obtain a multilayer clad material in which no alloy layer is formed at the joint interface of the third metallic plate and the second metallic plate and the thickness of the thinner metallic plate is controlled with a higher degree of accuracy. When the rolling reduction is less than 0.1%, a sufficient joint strength cannot be obtained between the third metallic plate and the second metallic plate. Further, when the rolling reduction exceeds 15%, there arise problems that the flatness of the joint interface cannot be obtained and cracks occur at the joint interface in the case of a combined metallic material forming a brittle alloy layer. Among other things, it is preferable that the rolling reduction is set to 0.1% to 10%, more preferably 0.1% to 5.0%.

The “rolling reduction” is a value obtained by the following calculation formula:

rolling reduction (%)={(X−Y)/X}×100,

where “X” (μm) is a total of the thickness (a total of the thickness of the laminated plate and the thickness of the third metallic plate) of the metallic plates to be subjected to cold pressure welding before being cold pressure welded by and between the pressure rolls 44 and 44, and “Y” (μm) is a thickness of the multilayer clad material 10 obtained by the clad rolling.

It is preferable that the temperature of the pressure rolls 44 at the time of executing the cold pressure welding in the cold pressure welding step is set within a range of 10° C. to 80° C., and in this case, it is possible to obtain a multilayer clad material 10 in which the thickness of the thinner metallic plate is controlled with a higher degree of accuracy.

In the first production method, like Example 1 which will be explained later, the first metallic plate, second metallic plate and third metallic plate are structured such that these three plates are made of dissimilar metallic materials, which is a major example but not limited to it.

According to the aforementioned first production method, the surface activation treatment is executed before the cold pressure welding and therefore oxides, absorbed substances, etc., on the joint scheduled surfaces are removed by the surface activation treatment to expose the cleaned surfaces, in the following cold pressure welding step, sufficient joint strength can be secured even at a low rolling reduction (0.1% to 15%). Therefore, in the first production method, no diffusion heat treatment (to improve the joint strength) is required after the cold pressure welding step, and therefore a diffusion heat treatment (normally, a heat treatment at 300° C. or above) is not executed after the cold pressure welding step. Therefore, according to the first production method, even in the case of using a wide width material, a multilayer clad material with no curve can be obtained.

### [Second Production Method]

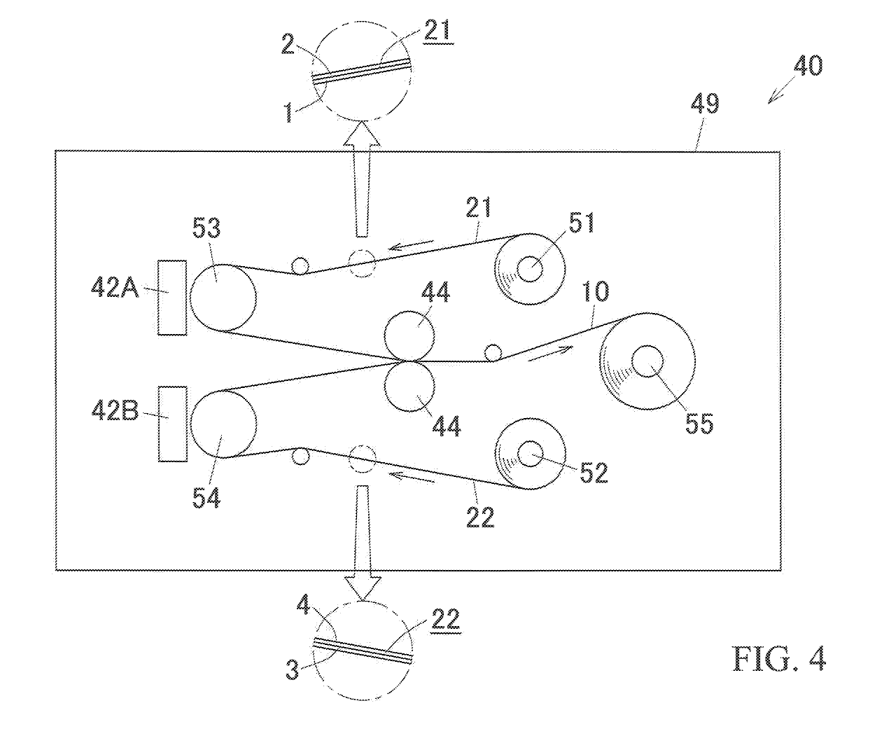

Next, a second production method of a multilayer clad material according to the present invention will be explained with reference to FIG. 4.

### (First Rolling Step)

By superposing a first metallic plate 1 and a second metallic plate 2 made of dissimilar metallic materials or same metallic material and clad rolling them at a rolling reduction of 25% to 85%, a first laminated plate 21 is obtained. For example, a nickel plate is used as the first metallic plate 1 and a titanium plate is used as the second metallic plate 2. That is, for example, by superposing the nickel plate 1 and the titanium plate 2 and clad rolling them at the rolling reduction of 25% to 85%, the first laminated plate 21 is obtained. The obtained first laminated plate 21 is rolled up on a first supply roll 51.

In this first rolling step, the first metallic plate 1 and the second metallic plate 2 are superposed and clad rolled, and therefore the first laminated plate 21 in which the first metallic plate 1 and the second metallic plate 2 are laminated can be obtained at low cost.

The clad rolling in the first rolling step is preferably performed by cold clad rolling. In this case, since it is not especially required to heat the material (metallic plate), the productivity can be improved. The temperature of the reduction roll at the time of the cold clad rolling is preferably set within a range of 10° C. to 120° C.

The “rolling reduction” is a value obtained by the following calculation formula:

rolling reduction (%)={(C−D)/C}×100,

where “C” (μm) is a total of the thickness of the first metallic plate and the thickness of the second metallic plate before clad rolling, and “D” (μm) is a thickness of the first laminated plate 21 obtained by the clad rolling.

Before the first rolling step, it is preferable to preliminarily perform mechanical polishing of the joint scheduled surface of the first metallic plate 1 and the joint scheduled surface of the second metallic plate 2. As the mechanical polishing, a method of polishing with a wire brush, for example, is exemplified, but the method is not specifically limited as long as it can mechanically remove a surface oxide layer of the joint scheduled surface. By performing such mechanical polishing (providing a mechanical polishing step), even by the clad rolling at the rolling reduction of, e.g., 25% to 70%, joining with sufficient joint strength can be attained.

Further, after the first rolling step but before the subsequent surface activation treatment step, the first laminated plate 21 obtained by the clad rolling can be subjected to a diffusion heat treatment at a heat treatment temperature of 500° C. to 700° C. By performing such diffusion heat treatment, the joint strength of the first metallic plate 1 and the second metallic plate 2 can be improved.

### (Second Rolling Step)

By superposing a third metallic plate 3 and a fourth metallic plate 4 made of dissimilar metallic materials or same metallic material and clad rolling them at a rolling reduction of 25% to 85%, a second laminated plate 22 is obtained. For example, an aluminum plate is used as the third metallic plate 3 and an aluminum brazing plate is used as the fourth metallic plate 4. That is, for example, by superposing the aluminum plate 3 and the aluminum brazing plate 4 and clad rolling them at the rolling reduction of 25% to 85%, the second laminated plate 22 is obtained. The obtained second laminated plate 22 is rolled up on a second supply roll 52.

In this second rolling step, the third metallic plate 3 and the fourth metallic plate 4 are superposed and clad rolled, and therefore the second laminated plate 22 in which the third metallic plate 3 and the fourth metallic plate 4 are laminated can be obtained at low cost.

The clad rolling in the second rolling step is preferably performed by cold clad rolling. In this case, since it is not especially required to heat the material (metallic plate), the productivity can be improved. The temperature of the reduction roll at the time of the cold clad rolling is preferably set within a range of 10° C. to 120° C.

The “rolling reduction” is a value obtained by the following calculation formula:

rolling reduction (%)={(E−F)/E}×100,

where “E” (μm) is a total of the thickness of the third metallic plate and the thickness of the fourth metallic plate before clad rolling, and “F” (μm) is a thickness of the second laminated plate 22 obtained by the clad rolling.

Before the second rolling step, it is preferable to preliminarily perform mechanical polishing of the joint scheduled surface of the third metallic plate 3 and the joint scheduled surface of the fourth metallic plate 4. As the mechanical polishing, a method of polishing with a wire brush, for example, is exemplified, but the method is not specifically limited as long as it can mechanically remove a surface oxide layer of the joint scheduled surface. By performing such mechanical polishing (providing a mechanical polishing step), even by the clad rolling at the rolling reduction of, e.g., 25% to 70%, joining with sufficient joint strength can be attained.

Further, after the second rolling step but before the subsequent surface activation treatment step, the second laminated plate 22 obtained by the clad rolling can be subjected to a diffusion heat treatment at a heat treatment temperature of 500° C. to 700° C. By performing such diffusion heat treatment, the joint strength of the third metallic plate 3 and the fourth metallic plate 4 can be improved.

The order of performing the first rolling step and the second rolling step is not specifically limited. The first rolling step can be performed initially, the second rolling step can be performed initially, or the first rolling step and the second rolling step can be performed simultaneously in parallel.

### (Surface Activation Treatment Step)

After performing both of the first rolling step and the second rolling step, a surface activation treatment step is performed. As shown in FIG. 4, the first supply roll 51 on which the first laminated plate 21 is wound is arranged in the vacuum chamber 49 of the production apparatus 40, and the other second supply roll 52 on which the second laminated plate 22 is wound is arranged in the vacuum chamber 49.

The vacuum chamber 49 is configured so that the interior space can be made into a vacuum state by a not-illustrated vacuum apparatus. In the vacuum chamber 49, the first electrode roll 53, a surface activation treatment apparatus 42A arranged apart from the first electrode roll 53 at a position close to the first electrode roll 53, a second electrode roll 54, a surface activation treatment apparatus 42B arranged apart from the second electrode roll 54 at a position closed to the second electrode roll 54, a pair of pressure rolls 44 and 44, and a wind-up roll 55 are arranged. The surface activation treatment apparatus 42A is configured to perform plasma etching processing of the surface of the metallic plate fitted on the outer peripheral surface of the first electrode roll 53 by applying a high-frequency voltage having a frequency of 10 MHz to 50 MHz between an electrode in the apparatus 42A and the first electrode roll 53 to irradiate plasma onto the surface of the metallic plate. In the same manner, the surface activation treatment apparatus 42B is configured to perform plasma etching processing of the surface of the metallic plate fitted on the outer peripheral surface of the second electrode roll 54 by applying a high-frequency voltage having a frequency of 10 MHz to 50 MHz between an electrode in the apparatus 42B and the second electrode roll 54 to irradiate plasma onto the surface of the metallic plate.

Next, the inside of the vacuum chamber 49 is maintained in a vacuum state. It is preferable that the degree of vacuum in the vacuum chamber 49 is set to 1×10⁻⁴ Pa to 1 Pa. Further, it is also preferable that the inside of the vacuum chamber 49 is filled with inert gas such as nitrogen, argon, etc., into an inert gas atmosphere and then the degree of vacuum is set to 1×10⁻⁴ Pa to 1 Pa by raising the degree of vacuum.

In the vacuum chamber 49 which is in a vacuum state, the first laminated plate 21 unwound from the first supply roll 51 is brought into contact with the outer peripheral surface of the first electrode roll 53 along the outer peripheral surface, plasma is irradiated from the surface activation treatment apparatus 42A onto the surface of the second metallic plate (e.g., titanium plate) 2 of the first laminated plate 21 in contact with the first electrode roll 53, and thereafter the laminated plate 21 is fed between the pair of pressure rolls 44 and 44 (see FIG. 4). By the plasma etching processing, it is possible to remove oxides, absorbed substances, etc., on the surface of the second metallic plate (e.g., titanium plate) 2 which is a joint scheduled surface of the first laminated plate 21 and expose the cleaned surface.

Simultaneously, in the vacuum chamber 49 which is in a vacuum state, the second laminated plate 22 unwound from the second supply roll 52 is brought into contact with the outer peripheral surface of the second electrode roll 54 along the outer peripheral surface, plasma is irradiated from the surface activation treatment apparatus 42B onto the surface (joint scheduled surface) of the third metallic plate (e.g., aluminum plate) 3 of the second laminated plate 22 in contact with the second electrode roll 54 to perform plasma etching processing of the third metallic plate (e.g., aluminum plate) 3, and thereafter the second laminated plate 22 is fed between the pair of pressure rolls 44 and 44 (see FIG. 4). By the plasma etching processing, it is possible to remove oxides, absorbed substances, etc., on the surface of the second metallic plate (e.g., aluminum plate) 3 which is a joint scheduled surface of the second laminated plate 22 and expose the cleaned surface.

### (Cold Pressure Welding Step)

Subsequently, in the vacuum chamber 49 which is in a vacuum state, the first laminated plate 21 and the second metallic plate 22 (e.g., titanium plate) are superposed so that the surface of the second metallic plate (e.g., titanium plate) 2 which is a joint scheduled surface of the first laminated plate 21 and the surface of the third metallic plate (e.g., aluminum plate) 3 which is a joint scheduled surface of the second laminated plate 22 are brought into contact with each other and cold pressure welded by and between the pair of pressure rolls 44 and 44 so that the rolling reduction becomes as low as 0.1% to 15% (see FIG. 4).

Then, in the vacuum chamber 49 which is in a vacuum state, the multilayer clad material 10 obtained by the cold pressure welding is wound on the wind-up roll 55 (see FIG. 4).

The obtained multilayer clad material 10 is, as shown in FIG. 2, provided with a four-layer laminated structure in which the first metallic plate (e.g., nickel plate) 1 is laminated on the upper surface of the second metallic plate (e.g., titanium plate) 2, the third metallic plate (e.g., aluminum plate) 3 is laminated on the lower surface of the second metallic plate (e.g., titanium plate) 2, and the fourth metallic plate (e.g., aluminum brazing plate) 4 is laminated on the lower surface of the third metallic plate (e.g., aluminum plate) 3.

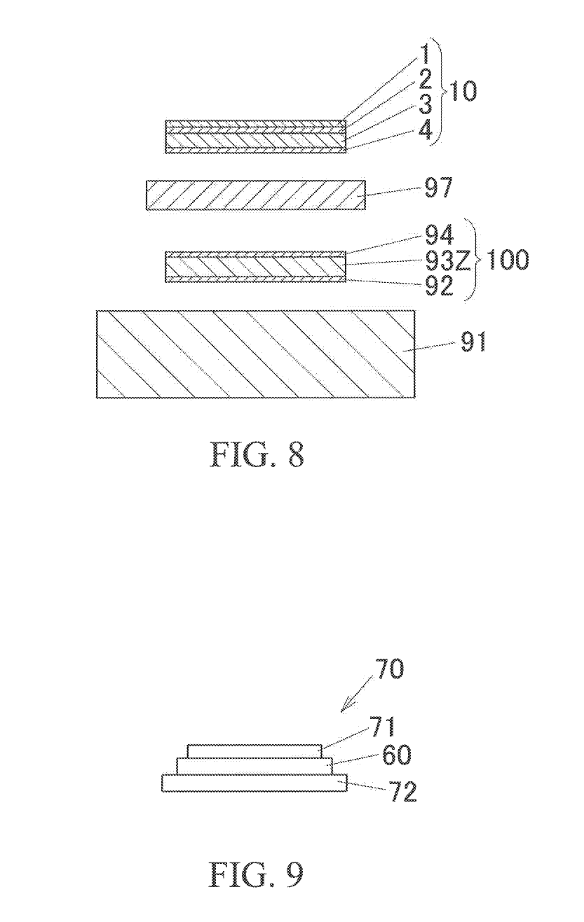

The multilayer clad material 10 having a four-layer laminated structure of the nickel plate 1/titanium plate 2/aluminum plate 3/aluminum brazing plate 4 can be used by being brazed directly to a semiconductor element joining surface side of a DBA substrate (cooler integrated insulating substrate) 95 (see FIG. 7) or by being brazed directly to a ceramic plate 97 (see FIG. 8).

FIG. 7 is a schematic cross-sectional view showing an example of a cooler integrated insulating substrate in an exploded state before lamination. In FIG. 7, the reference symbol “91” denotes an aluminum plate as a heat dissipation member, “92” denotes an aluminum brazing foil, “93” denotes an aluminum punching plate, “94” denotes an aluminum brazing foil, and “95” denotes a DBA (Al layer 96/AlN layer (aluminum nitride layer) 97/Al layer 98).

FIG. 8 is a schematic cross-sectional view showing another example of a cooler integrated insulating substrate in an exploded state before lamination. In FIG. 8, the reference symbol “91” denotes an aluminum plate as a heat dissipation member, “100” denotes a clad material (aluminum brazing material 92/aluminum plate 93Z/aluminum brazing material 94), and “97” denotes a ceramic plate (Aluminum nitride layer).

The titanium plate 2 functions as a barrier layer which prevents a brittle alloy layer from being created due to the contact of the nickel plate 1 and the aluminum plate 3. Ti is 21.9 W/m·K in thermal conductivity, and the thermal conductivity is remarkably low as compared with Ni of 90.7 W/m·K, or Al of 236 W/m·K. Therefore, in the use of an insulating substrate which requires high heat dissipation characteristics, it is preferable that the titanium plate 2 is set to be thin, specifically 3 μm to 30 μm.

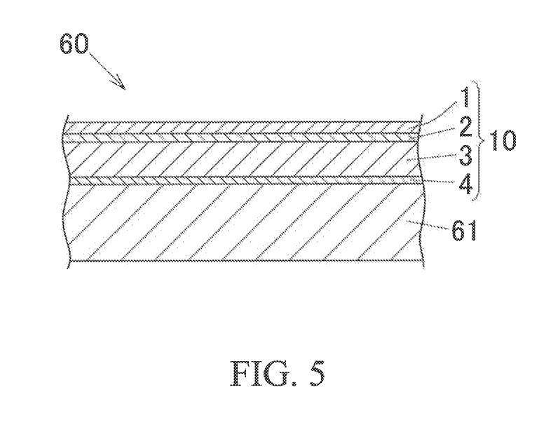

Further, as to the aluminum plate 3, the thickness design differs substantially between the case of joining to a DBA•heat sink•cooler and the case of using as a wiring layer by directly joining to a ceramic plate. In cases where the aluminum plate is joined directly to a ceramic plate 61 and used as a wiring layer (see FIG. 5), it is preferable that the thickness of the aluminum plate 3 of the multilayer clad material 10 having a four-layer laminated structure is set to 200 μm to 800 μm to control increase of electric resistance. On the other hand, in cases where the aluminum plate is used as a use of brazing to a DBA plate, in order to prevent the contact of the Ti layer 2 and the brazing layer 4 at the time of brazing, it is preferable that the thickness of the aluminum plate 3 in the multilayer clad material 10 having a four-layer laminated structure is 40 μm or more.

In the aforementioned cold pressure welding step, the rolling reduction is set to 0.1% to 15%. By setting the rolling reduction to the range, it is possible to further improve the flatness of the joint interface of the third metallic plate and the second metallic plate, and also possible to obtain a multilayer clad material 10 in which no alloy layer is formed at the joint interface of the third metallic plate and the second metallic plate and the thickness of the thinner metallic plate is controlled with a higher degree of accuracy. When the rolling reduction is less than 0.1%, a sufficient joint strength cannot be obtained between the third metallic plate and the second metallic plate. Further, when the rolling reduction exceeds 15%, there arise problems that the flatness of the joint interface cannot be obtained and cracks occur at the joint interface in the case of a combined metallic material forming a brittle alloy layer. Among other things, it is preferable that the rolling reduction is set to 0.1% to 10%, more preferably 0.1% to 5.0%.

The “rolling reduction” is a value obtained by the following calculation formula:

rolling reduction (%)={(X−Y)/X}×100,

where “X” (μm) is a total thickness (the total of the thickness of the first laminated plate and the thickness of the second laminated plate) of the metallic plates to be subjected to a cold pressure welding before being cold press welded by and between the pressure rolls 44 and 44, and “Y” (μm) is a thickness of the multilayer clad material 10 obtained by the clad rolling.

It is preferable that the temperature of the pressure rolls 44 at the time of executing the cold pressure welding in the cold pressure welding step is set within a range of 10° C. to 80° C. In this case, it is possible to obtain a multilayer clad material 10 in which the thickness of the thinner metallic plate is controlled with a higher degree of accuracy.

In the second production method, like Example 3 which will be explained later, the first metallic plate, second metallic plate, third metallic plate and fourth metallic plate are structured such that these four plates are made of dissimilar metallic materials, which is a major example but not limited to it.

According to the aforementioned second production method, the surface activation treatment is executed before the cold pressure welding and therefore oxides, absorbed substances, etc., on the joint scheduled surfaces are removed by the surface activation treatment to expose the cleaned surfaces, in the following cold pressure welding step, sufficient joint strength can be secured even at a low rolling reduction (0.1% to 15%). Therefore, in the second production method, no diffusion heat treatment (to improve the joint strength) is required after the cold pressure welding step, and therefore a diffusion heat treatment (normally, a heat treatment at 300° C. or above) is not executed after the cold pressure welding step. Therefore, according to the second production method, even in the case of using a wide width material, a multilayer clad material with no curve can be obtained.

### [First and Second Production Methods]

In the production methods according to the present invention, the first metallic plate, second metallic plate and third metallic plate are not specifically limited, but for example, a nickel plate, a titanium plate, an aluminum plate, etc., can be exemplified. Further, as the fourth metallic plate, it is not specifically limited, but for example, a nickel plate, a titanium plate, an aluminum plate, an aluminum brazing plate, etc., can be exemplified.

In the production method of the present invention, by adding other steps other than the aforementioned steps, a multilayer clad material having a five-layer laminated structure, a six-layer laminated structure, or a seven or more layer laminated structure can be produced, and it should be noted that the production method of the present invention includes such production methods.

An example of a semiconductor module 70 produced by using the multilayer clad material 10 produced by the production method of the present invention as a part of the constituent material is shown in FIG. 9. In this semiconductor module 70, a semiconductor element 71 is joined on the upper surface of the nickel layer (nickel plate) 1 of the insulating substrate 60 having the structure shown in FIG. 5, and the heat dissipation member 72 is joined to the lower surface of the ceramic layer 61 of the insulating substrate 60. The semiconductor element 71 is joined to the nickel layer 1 of the insulating substrate 60 by soldering.

As the semiconductor element 71, it is not specifically limited, but for example, an IGBT chip, a MOSFET chip, a thyristor chip, a diode chip, etc., can be exemplified. As the heat dissipation member 72, it is not specifically limited, but, for example, a heat sink, a cooler, etc., can be exemplified.

The insulating substrate 60 is to transfer the heat generated from the semiconductor element 71 in accordance with the operation of the semiconductor element 71 to the heat dissipation member 72, and is a conductor thermally but functions as an insulating material electrically.

### EXAMPLES

Next, concrete examples of the present invention will be explained, but it should be understood that the present invention is not limited to these examples.

### Example 1

After polishing the joint scheduled surfaces of a nickel plate 1 having a thickness of 60 μm and a titanium plate 2 having a thickness of 40 μm with a wire brush, the nickel plate 1 and the titanium plate 2 were superposed and cold clad rolled (the temperature of the reduction roll: 25° C.) at a rolling reduction of 50%, to thereby obtain a laminated plate 20 having a thickness of 50 μm and a width of 200 mm in which the nickel plate 1 and the titanium plate 2 were laminated (Rolling Step). Then, the laminated plate 20 was subjected to a diffusion heat treatment at 600° C.

Using the apparatus 40 shown in FIG. 3, in the vacuum chamber 49 set to 1×10⁻³ Pa, plasma was irradiated to the surface (joint scheduled surface) of the titanium plate 2 of the laminated plate 20 and the surface (joint scheduled surface) of the aluminum plate 3 having a thickness of 85 μm and a width of 200 mm, to thereby execute plasma etching processing of these surfaces (Surface Activation Treatment Step).

Subsequently, as shown in FIG. 3, in the vacuum chamber 49 set to 1×10⁻³ Pa, the laminated plate 20 and the aluminum plate 3 were superposed so that the surface (etching processed surface) of the titanium plate 2 of the laminated plate 20 and the surface (etching processed surface) of the aluminum plate 3 were brought into contact with each other, and both these plates were cold pressure welded by and between a pair of pressure rolls 44 and 44 at 25° C. (room temperature), to thereby obtain a multilayer clad material 10 having a thickness of 130 μm and a width of 200 mm (Cold Pressure Welding Step).

The obtained multilayer clad material 10 has, as shown in FIG. 1, a three-layer laminated structure in which a nickel plate 1 having a thickness of 30 μm, a titanium plate 2 having a thickness of 20 μm, and an aluminum plate 3 having a thickness of 80 μm were integrally laminated in this order. Therefore, the rolling reduction in the cold pressure welding step was

100×{(50+85)−130}/(50+85)=3.7

The rolling reduction was 3.7% from the above calculation formula.

### Example 2

After polishing the joint scheduled surfaces of a nickel plate 1 having a thickness of 60 μm and a titanium plate 2 having a thickness of 410 μm with a wire brush, the nickel plate 1 and the titanium plate 2 were superposed and cold clad rolled (the temperature of the reduction roll: 25° C.) at a rolling reduction of 50%, to thereby obtain a laminated plate 20 having a thickness of 50 μm and a width of 200 mm in which the nickel plate 1 and the titanium plate 2 were laminated (Rolling Step). Then, the laminated plate 20 was subjected to a diffusion heat treatment at 600° C.

Using the apparatus 40 shown in FIG. 3, in the vacuum chamber 49 set to 1×10⁻³ Pa, plasma was irradiated to the surface (joint scheduled surface) of the titanium plate 2 of the laminated plate 20 and the surface (joint scheduled surface) of the aluminum plate 3 having a thickness of 610 μm and a width of 200 mm, to thereby execute plasma etching processing of these surfaces (Surface Activation Treatment Step).

Subsequently, as shown in FIG. 3, in the vacuum chamber 49 set to 1×10⁻³ Pa, the laminated plate 20 and the aluminum plate 3 were superposed so that the surface (etching processed surface) of the titanium plate 2 of the laminated plate 20 and the surface (etching processed surface) of the aluminum plate 3 were brought into contact with each other, and both these plates were cold pressure welded by and between a pair of pressure rolls 44 and 44 at 25° C. (room temperature), to thereby obtain a multilayer clad material 10 having a thickness of 650 μm and a width of 200 mm (Cold Pressure Welding Step).

The obtained multilayer clad material 10 has, as shown in FIG. 1, a three-layer laminated structure in which a nickel plate 1 having a thickness of 30 μm, a titanium plate 2 having a thickness of 20 μm, and an aluminum plate 3 having a thickness of 600 μm were integrally laminated in this order. Therefore, the rolling reduction in the cold pressure welding step was

100×{(50+610)−650}/(50+610)=1.5

The rolling reduction was 1.5% from the above calculation formula.

### Example 3

After polishing the joint scheduled surfaces of a nickel plate 1 having a thickness of 60 μm and a titanium plate 2 having a thickness of 40 μm with a wire brush, the nickel plate 1 and the titanium plate 2 were superposed and cold clad rolled (the temperature of the reduction roll: 25° C.) at a rolling reduction of 50%, to thereby obtain a first laminated plate 21 having a thickness of 50 μm and a width of 200 mm in which the nickel plate 1 and the titanium plate 2 were laminated (First Rolling Step). Then, the first laminated plate 21 was subjected to a diffusion heat treatment at 600° C.

After polishing the joint scheduled surfaces of an aluminum plate 3 having a thickness of 180 μm and an aluminum brazing plate (Al-si alloy plate in which the Si content rate was 10 mass % and the Al content rate was 90 mass %) 4 having a thickness of 50 μm with a wire brush, the aluminum plate 3 and the aluminum plate 4 were superposed and clad rolled (the temperature of the reduction roll: 25° C.) at a rolling reduction of 54%, to thereby obtain a second laminated plate 22 having a thickness of 105 μm and a width of 200 mm in which the aluminum plate 3 and the aluminum plate 4 were laminated (Second Rolling Step).

Using the apparatus 40 shown in FIG. 4, in the vacuum chamber 49 set to 1×10⁻³ Pa, plasma was irradiated to the surface (joint scheduled surface) of the titanium plate 2 of the first laminated plate 21 and the surface (joint scheduled surface) of the aluminum plate 3 of the second laminated plate 22, to thereby execute plasma etching processing of these surfaces (Surface Activation Treatment Step).

Subsequently, as shown in FIG. 4, in the vacuum chamber 49 set to 1×10⁻³ Pa, the first laminated plate 21 and the second laminated plate 22 were superposed so that the surface (etching processed surface) of the titanium plate 2 of the first laminated plate 21 and the surface (etching processed surface) of the aluminum plate 3 of the second laminated plate 22 were brought into contact with each other, and both these plates were cold pressure welded by and between a pair of pressure rolls 44 and 44 at 25° C. (room temperature), to thereby obtain a multilayer clad material 10 having a thickness of 150 μm and a width of 200 mm (Cold Pressure Welding Step).

The obtained multilayer clad material 10 has, as shown in FIG. 2, a four-layer laminated structure in which a nickel plate 1 having a thickness of 30 μm, a titanium plate 2 having a thickness of 20 μm, an aluminum plate 3 having a thickness of 80 μm, and an aluminum brazing plate 4 having a thickness of 20 μm were integrally laminated in this order. Therefore, the rolling reduction in the cold pressure welding step was

100×{(50+105)−150}/(50+105)=3.2

The rolling reduction was 3.2% from the above calculation formula.

### Example 4

After polishing the joint scheduled surfaces of a nickel plate 1 having a thickness of 60 μm and a titanium plate 2 having a thickness of 40 μm with a wire brush, the nickel plate 1 and the titanium plate 2 were superposed and cold clad rolled (the temperature of the reduction roll: 25° C.) at a rolling reduction of 50%, to thereby obtain a first laminated plate 21 having a thickness of 50 μm and a width of 200 mm in which the nickel plate 1 and the titanium plate 2 were laminated (First Rolling Step). Then, the first laminated plate 21 was subjected to a diffusion heat treatment at 600° C.

After polishing the joint scheduled surfaces of an aluminum plate 3 having a thickness of 1,400 μm and an aluminum brazing plate (Al-si alloy plate in which the Si content rate was 10 mass % and the Al content rate was 90 mass %) 4 having a thickness of 50 μm with a wire brush, the aluminum plate 3 and the aluminum brazing plate 4 were superposed and cold clad rolled (the temperature of the reduction roll: 25° C.) at a rolling reduction of 57%, to thereby obtain a second laminated plate 22 having a thickness of 630 μm and a width of 200 mm in which the aluminum plate 3 and the aluminum plate 4 were laminated (Second Rolling Step).

Using the apparatus 40 shown in FIG. 4, in the vacuum chamber 49 set to 1×10⁻³ Pa, plasma was irradiated to the surface (joint scheduled surface) of the titanium plate 2 of the first laminated plate 21 and the surface (joint scheduled surface) of the aluminum plate 3 of the second laminated plate 22, to thereby execute plasma etching processing of these surfaces (Surface Activation Treatment Step).

Subsequently, as shown in FIG. 4, in the vacuum chamber 49 set to 1×10⁻³ Pa, the first laminated plate 21 and the second laminated plate 22 were superposed so that the surface (etching processed surface) of the titanium plate 2 of the first laminated plate 21 and the surface (etching processed surface) of the aluminum plate 3 of the second laminated plate 22 were brought into contact with each other, and both these plates were cold pressure welded by and between a pair of pressure rolls 44 and 44 at 25° C. (room temperature), to thereby obtain a multilayer clad material 10 having a thickness of 670 μm and a width of 200 mm (Cold Pressure Welding Step).

The obtained multilayer clad material 10 has, as shown in FIG. 2, a four-layer laminated structure in which a nickel plate 1 having a thickness of 30 μm, a titanium plate 2 having a thickness of 20 μm, an aluminum plate 3 having a thickness of 600 μm, and an aluminum brazing plate 4 having a thickness of 20 μm were integrally laminated in this order. Therefore, the rolling reduction in the cold pressure welding step was

100×{(50+630)−670}/(50+630)=1.5

The rolling reduction is 1.5% from the above calculation formula.

### Comparative Example 1

After polishing the joint scheduled surfaces of a nickel plate having a thickness of 120 μm and a titanium plate having a thickness of 80 μm with a wire brush, the nickel plate and the titanium plate were superposed and cold clad rolled (the temperature of the reduction roll: 25° C.) at a rolling reduction of 50%, to thereby obtain a laminated plate having a thickness of 100 μm and a width of 200 mm in which the nickel plate and the titanium plate were laminated (First Rolling Step). Then, the laminated plate was subjected to a diffusion heat treatment at 600° C.

Then, after polishing a surface (joint scheduled surface) of a titanium plate of the laminated plate and a surface (joint scheduled surface) of an aluminum plate having a thickness of 160 μm and a width of 200 μm with a wire brush, the laminated plate and the aluminum plate were superposed and cold clad rolled (the temperature of the reduction roll: 25° C.) at a rolling reduction of 50%, to thereby obtain a multilayer clad material 10 of a three-layer laminated plate (Second Rolling Step).

Next, in order to improve the joint strength of the joint interface, a diffusion heat treatment was performed at 300° C. for 10 minutes, but there occurred curves and undulations in the laminated plate because of the wide width of 200 mm, which made it difficult to roll up on the wind-up roll (no actual production could be performed).

### Comparative Example 2

After polishing the joint scheduled surfaces of a nickel plate having a thickness of 120 μm and a titanium plate having a thickness of 80 μm with a wire brush, the nickel plate and the titanium plate were superposed and cold clad rolled (the temperature of the reduction roll: 25° C.) at a rolling reduction of 50%, to thereby obtain a laminated plate having a thickness of 100 μm and a width of 30 mm in which the nickel plate and the titanium plate were laminated (First Rolling Step). Then, the laminated plate was subjected to a diffusion heat treatment at 600° C.

Then, after polishing a surface (joint scheduled surface) of a titanium plate of the laminated plate (width 30 mm) and a surface (joint scheduled surface) of an aluminum plate having a thickness of 600 μm and a width of 30 mm with a wire brush, the laminated plate and the aluminum plate were superposed and cold clad rolled (the temperature of the reduction roll: 25° C.) at a rolling reduction of 50%, to thereby obtain a multilayer clad material 10 of a three-layer laminated clad material (Second Rolling Step).

The cross-section of the obtained multilayer clad material was observed with an electron microscope, and the observation found that the titanium plate (titanium layer) was broken.

### Comparative Example 3

After polishing the joint scheduled surfaces of a nickel plate having a thickness of 60 μm and a titanium plate having a thickness of 40 μm with a wire brush, the nickel plate and the titanium plate were superposed and cold clad rolled (the temperature of the reduction roll: 25° C.) at a rolling reduction of 50%, to thereby obtain a laminated plate having a thickness of 50 μm and a width of 200 mm in which the nickel plate and the titanium plate were laminated (First Rolling Step). Then, the laminated plate was subjected to a diffusion heat treatment at 600° C.

Then, after polishing a surface (joint scheduled surface) of a titanium plate of the laminated plate and a surface (joint scheduled surface) of an aluminum plate having a thickness of 133 μm and a width of 200 mm with a wire brush, the laminated plate and the aluminum plate were superposed and cold clad rolled (the temperature of the reduction roll: 25° C.) at a rolling reduction of 2% (Second Rolling Step), to try to obtain a multilayer clad material, but the laminated plate and the aluminum plate could not be joined.

### Comparative Example 4

A production of a multilayer clad material was attempted in the same manner as in Example 1 except that the rolling reduction in the cold pressure welding step was set so as to become 0.05%, but the laminated plate and the aluminum plate were not joined.

### Comparative Example 5

A multilayer clad material having a thickness of 130 μm and a width of 200 mm was obtained in the same manner as in Example 1 except that the rolling reduction in the cold pressure welding step was set so as to become 25%.

On each multilayer clad material obtained as mentioned above, evaluation was performed based on the following evaluation method. These evaluation results are shown in Table 1.

### <Evaluation Method for Presence of Generation of Curves and Undulations in Multilayer Clad Material>

Presence of curves and undulations on the surface (Ni layer surface) of the obtained multilayer clad material was examined using a laser type shape measuring instrument.

### <Evaluation Method for Presence of Generation of Breakages of Each Constituent Layer of Multilayer Clad Material>

The cross-section of the obtained multilayer clad material was observed with an electron microscope, and the presence of breakages in each constituent layer was examined.

TABLE 1

| | Joining method | | | | | | |
|---|---|---|---|---|---|---|---|
| | | Joining method to obtain | Cold Pressure | | | Obtained Multilayer clad material | |
| | Joining method | a multilayer clad material | Welding Step | | | Presence of | |
| | to obtain a | using the two-layer | Thickness | | Rolling | occurrence of | Presence of |
| | two-layer | laminated plate obtained | (μm) | | reduction | curves, | breakages of |
| | laminated plate | by the left method | X | Y | (%) | undulations | constituent layer |
| Ex. 1 | Clad rolling | Cold pressure welding | 135 | 130 | 3.7 | Nil | Nil |
| Ex. 2 | Clad rolling | Cold pressure welding | 660 | 650 | 1.5 | Nil | Nil |
| Ex. 3 | Clad rolling | Cold pressure welding | 155 | 150 | 3.2 | Nil | Nil |
| Ex. 4 | Clad rolling | Cold pressure welding | 680 | 670 | 1.5 | Nil | Nil |
| Comp. Ex. 1 | First clad rolling | Second clad rolling | | | | Occurred | Nil |
| | | | | | | remarkably | |
| Comp. Ex. 2 | First clad rolling | Second clad rolling | | | | Nil | Ti layer broken |

| | | | | | | |
|---|---|---|---|---|---|---|
| Comp. Ex. 3 | First clad rolling | Second clad rolling | | | | (could not be joined) |
| Comp. Ex. 4 | Clad rolling | Cold pressure welding | 130.07 | (130) | 0.05 | (Good joint could not be attained) |
| Comp. Ex. 5 | Clad rolling | Cold pressure welding | 174 | 130 | 25 | (Cracks generated in alloy portion of |
| | | | | | | joint interface) |

X: Total thickness (μm) of a metallic plate to be pressure welded before cold pressure welding
Y: Thickness (μm) of multilayer clad material obtained by cold pressure welding

As will be apparent from Table 1, in the multilayer clad materials of Examples 1 to 4 produced by a production method of the present invention, the thickness of one of metallic plates to be laminated in the cold pressure welding differs significantly from the thickness of the other metallic plate (over 2.0 times or less than 0.5 times). Nevertheless, the thickness of the thinner metallic plate was controlled with a high degree of accuracy, and that no curves or undulations were generated and no breakage of constituent layer occurred. Further, in the multilayer clad material of Examples 1 to 4, although the width was as wide as 200 mm, no curve or undulation occurred.

On the other hand, in Comparative Example 1, curves and undulations were generated by the diffusion heat treatment to improve the joint strength of the joint interface, it was difficult to roll up the clad material, which prevented an actual production. Further, in Comparative Example 2, in the second rolling step, since the difference between the thicknesses of plates to be superposed was significant (one was 100 μm, and the other was 600 μm), the thinner titanium layer (titanium plate) was broken. In Comparative Example 3, in the second rolling step, since the cold clad rolling was performed at the rolling reduction of 2%, the laminated plate and the aluminum plate could not be joined.

Further, in Comparative Example 4, since the rolling reduction in the cold pressure welding was smaller than the range defined by the present invention, the laminated plate and the aluminum plate could not be joined in a good manner. Further, in Comparative Example 5, since the rolling reduction in the cold pressure welding step was larger than the range defined by the present invention, cracks were generated in the interface of the laminated plate and the aluminum plate.

### INDUSTRIAL APPLICABILITY

The multilayer clad material produced by the production method of a multilayer clad material according to the present invention can be preferably used as, for example, a multilayered material for insulating substrates to release heat of a semiconductor element, but not limited to it. The multilayer clad material produced by the production method of the present invention is used as apart of a constituent material to produce, for example, an insulating substrate, a semiconductor module, etc.

The present invention claims priority to Japanese Patent Application No. 2013-104698 filed on May 17, 2013, the entire disclosure of which is incorporated herein by reference in its entirety.

The terms and descriptions used herein are used only for explanatory purposes and the present invention is not limited to them. The present invention allows various design-changes falling within the claimed scope of the present invention unless it deviates from the spirits of the invention.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

### DESCRIPTION OF THE REFERENCE NUMERALS

1 . . . first metallic plate
2 . . . second metallic plate
3 . . . third metallic plate
4 . . . fourth metallic plate
10 . . . multilayer clad material
20 . . . laminated plate
21 . . . first laminated plate
22 . . . second laminated plate
40 . . . apparatus
42A, 42B . . . surface activation treatment apparatus
44 . . . pressure roll
49 . . . vacuum chamber

1. A production method of a multilayer clad material, comprising:
a rolling step of obtaining a laminated plate by clad rolling a first metallic plate and a second metallic plate made of dissimilar metallic materials or same metallic material in a superposed manner at a rolling reduction of 25% to 85%;
a surface activation treatment step of subjecting at least a joint scheduled surface of the laminated plate and at least a joint scheduled surface of a third metallic plate to a surface activation treatment in vacuum; and
a cold pressure welding step of, after performing the surface activation treatment, in vacuum, cold pressure welding the laminated plate and the third metallic plate by and between a pair of pressure rolls so that a rolling reduction becomes 0.1% to 15% in a superposed manner that the joint scheduled surface of the laminated plate and the joint scheduled surface of the third metallic plate are in contact with each other.

2. The production method of a multilayer clad material as recited in claim 1, wherein
a thickness of the first metallic plate is 0.5 to 2.0 times a thickness of the second metallic plate, and
a thickness of the third metallic plate is over 2.0 times or less than 0.5 times a thickness of the second metallic plate.

3. The production method of a multilayer clad material as recited in claim 1, wherein a thickness of at least one of metallic plates between the first metallic plate and the second metallic plate is 100 μm or less.

4. A production method of a multilayer clad material, comprising:
a rolling step of obtaining a laminated plate by clad rolling a nickel plate and a titanium plate in a superposed manner at a rolling reduction of 25% to 85%;
a surface activation treatment step of subjecting at least a surface of the titanium plate of the laminated plate and at least a joint scheduled surface of an aluminum plate to a surface activation treatment in vacuum; and
a cold pressure welding step of, after performing the surface activation treatment, in vacuum, cold pressure welding the laminated plate and the aluminum plate by and between a pair of pressure rolls so that a rolling reduction becomes 0.1% to 15% in a superposed manner that the surface of the titanium plate of the laminated plate and a joint scheduled surface of the aluminum plate are in contact with each other.

5. The production method of a multilayer clad material as recited in claim 4, wherein
a thickness of the nickel plate is 0.5 to 2.0 times a thickness of the titanium, and
a thickness of the aluminum plate is over 2.0 times or less than 0.5 times a thickness of the titanium plate.

6. The production method of a multilayer clad material as recited in claim 4, wherein
a thickness of the nickel plate is 10 to 100 μm,
a thickness of the titanium plate is 5 to 30 μm, and
a thickness of the aluminum plate is within a range of over 60 μm to 10 mm or less.

7. A production method of a multilayer clad material, comprising:
a first rolling step of obtaining a first laminated plate by clad rolling a first metallic plate and a second metallic plate made of dissimilar metallic materials or same metallic material in a superposed manner at a rolling reduction of 25% to 85%;
a second rolling step of obtaining a second laminated plate by clad rolling a third metallic plate and a fourth metallic plate made of dissimilar metallic materials or same metallic material in a superposed manner at a rolling reduction of 25% to 85%;
a surface activation treatment step of subjecting at least a joint scheduled surface of the first laminated plate and at least a joint scheduled surface of a second laminated plate to a surface activation treatment in vacuum; and
a cold pressure welding step of, after performing the surface activation treatment, in vacuum, cold pressure welding the first laminated plate and the second laminated plate by and between a pair of pressure rolls so that a rolling reduction becomes 0.1% to 15% in a superposed manner that the joint scheduled surface of the first laminated plate and the joint scheduled surface of the second laminated plate are in contact with each other.

8. The production method of a multilayer clad material as recited in claim 7, wherein
a thickness of the first metallic plate is 0.5 to 2.0 times a thickness of the second metallic plate,
a thickness of the fourth metallic plate is 0.5 to 2.0 times a thickness of the third metallic plate, and
a thickness of the third metallic plate is over 2.0 times or less than 0.5 times a thickness of the second metallic plate.

9. The production method of a multilayer clad material as recited in claim 7, wherein a thickness of at least one metallic plate among the first to fourth metallic plates is 100 μm or less.

10. A production method of a multilayer clad material, comprising:
a first rolling step of obtaining a first laminated plate by clad rolling a nickel plate and a titanium plate in a superposed manner at a rolling reduction of 25% to 85%;
a second rolling step of obtaining a second laminated plate by clad rolling an aluminum plate and a brazing plate in a superposed manner at a rolling reduction of 25% to 85%;
a surface activation treatment step of subjecting at least a surface of the titanium plate of the first laminated plate and at least a surface of the aluminum plate of the second laminated plate to a surface activation treatment in vacuum; and
a cold pressure welding step of, after performing the surface activation treatment, in vacuum, cold pressure welding the first laminated plate and the second laminated plate by and between a pair of pressure rolls at a rolling reduction of 0.1% to 15% in a superposed manner that a surface of the titanium plate of the first laminated plate and a surface of the aluminum plate of the second laminated plate are in contact with each other.

11. The production method of the multilayer clad material as recited in claim 10, wherein
a thickness of the nickel plate is 0.5 to 2.0 times a thickness of the titanium plate,
a thickness of the brazing plate is 0.5 to 2.0 times a thickness of the aluminum plate, and
a thickness of the aluminum plate is over 2.0 times or less than 0.5 times a thickness of the titanium plate.

12. The production method of the multilayer clad material as recited in claim 10, wherein
a thickness of the nickel plate is 10 μm to 100 μm, a thickness of the titanium plate is 5 μm to 30 μm,
a thickness of the aluminum plate is within a range of over 60 μm to 10 mm or less, and
a thickness of the brazing plate is 10 μm to 60 μm.

13. The production method of the multilayer clad material as recited in claim 1, wherein the surface activation treatment is plasma etching processing.

14. The production method of the multilayer clad material as recited in claim 1, wherein a temperature of the pressure rolls at a time of the cold pressure welding in the cold pressure welding step is within a range of 10° C. to 80° C.

15. The production method of the multilayer clad material as recited in claim 1, wherein the rolling reduction of the clad rolling in the rolling step is 45% to 65%.

16. The production method of the multilayer clad material as recited in claim 1, wherein the multilayer clad material is a multilayered material for insulating substrates.
